(19) United States
(12) Patent Application Publication
(10) Pub. No.: US 2009/0272809 A1
(43) Pub. Date: Nov. 5, 2009

(54) Bar Code Reading Apparatus and Bar Code Reading Method

(75) Inventor: Hajime Matsuda, Osaka (JP)

Correspondence Address: KILYK & BOWERSOX, P.L.L.C., 400 HOLIDAY COURT, SUITE 102, WARRENTON, VA, 20186, US

(73) Assignee: Keyence Corporation, Osaka (JP)

(21) Appl. No.: 12/420,886

(22) Filed: Apr. 9, 2009

(30) Foreign Application Priority Data
Apr. 30, 2008 (JP) 2008-118712

(51) Int. Cl. G06K 7/10

(52) U.S. Cl. 235/462.25; 235/462.01

(57) ABSTRACT

Reading result information about whether bar code information has been able to be read normally in a scanning cycle unit is stored in association with a plurality of locations and information on a condition set upon reading. When it is determined, based on stored reading result information which is obtained in an immediately previous scanning cycle, that bar code information in an identical relative location in the immediately previous scanning cycle has been able to be read normally, information on a condition set upon reading in the immediately previous scanning cycle is read. When it is determined that bar code information has not been able to be read normally, information on a condition that differs from information on a condition set upon reading in the immediately previous scanning cycle is set.

### CROSS-REFERENCE TO RELATED APPLICATIONS

The present application claims foreign priority based on Japanese Patent Application No. 2008-118712, filed Apr. 30, 2008, the contents of which is incorporated herein by reference.

### BACKGROUND OF THE INVENTION

1. Field of the Invention

The present invention relates to a raster scan type bar code reading apparatus and a bar code reading method. More particularly, the present invention relates to a raster scan type bar code reading apparatus and a bar code reading method that are capable of making optimal gain adjustment based on a reading result.

2. Description of the Related Art

Conventionally, numbers of bar code readers have been developed that use semiconductor laser as a light-emitting element and scan a bar code by a light beam. To ensure scanning of a bar code, a light-receiving element needs to receive reflected light of a light beam emitted from a light-emitting element, at an appropriate intensity of received light.

For example, Japanese Patent No. 2612617 discloses a scanning apparatus capable of adjusting an amount of light received by a light-receiving element, by changing a scan width with which a bar code is scanned. In Japanese Patent No. 2612617, by increasing or decreasing the amount of light received by the light-receiving element by switching between a first scan mode in which the scan width is set at a narrow angle and a second scan mode in which the scan width is set at a wide angle, an adjustment is made so that a bar code can be properly scanned.

More specifically, as disclosed in Japanese Patent No. 3058941, for example, when a scan width with which a bar code is scanned is set at a narrow angle, the amount of light received by a light-receiving element which is present in a scan range is increased to make identification of a scan portion of the bar code easier, and after the identification, the scan width is adjusted to a wide angle to make the entire bar code to be a scan range.

In the scanning apparatuses disclosed in Japanese Patent Nos. 2612617 and 3058941, a gain value of an amplifier circuit is controlled such that the intensity of received reflected light from a bar code converges within a certain range. Hence, normally, an amount of received light obtained when immediately pervious scanning is performed is stored and a gain value is increased or decreased based on the stored past amount of received light such that the intensity of received light converges within a certain range.

However, in a case of a bar code reading apparatus of a raster scan type in which there are a plurality of scanning lines, when a bar code is affixed to a cylindrical to-be-detected object or when only some of scanning lines hit a bar code area, or the like, an optimal reading condition varies between scanning lines. Hence, when gain values are uniformly increased or decreased as in the conventional cases, even though an appropriate amount of received light can be ensured for a certain scanning line, the amount of received light may be too large or too small for other scanning lines, causing a problem that a bar code may not be able to be read normally.

It may be considered to obtain a gain value as an average value, based on past amounts of received light of reflected light; however, once a too large or too small amount of received light is stored, it requires a considerable amount of time for a gain value to converge. Therefore, there is a problem that it takes time for bar code reading to be stabilized after a start of bar code reading.

The present invention is made in view of the above-described circumstances and an object of the present invention is therefore to provide a bar code reading apparatus and a bar code reading method that are capable of converging a gain value at which bar code reading is stabilized, in a relatively short period of time.

### SUMMARY OF THE INVENTION

In order to achieve the above object, a bar code reading apparatus according to a first aspect of the present invention includes: a light-emitting element that emits light; a mirror mechanism that changes an emission direction of the light emitted from the light-emitting element so that the light can cyclically scan a bar code at a plurality of different locations, with certain regularity; and a light-receiving element that receives reflected light from the bar code, and obtaining bar code information based on a received-light signal obtained by photoelectrically converting reflected light for each scanning line received by the light-receiving element, the bar code reading apparatus includes: a reading result storing unit that stores reading result information about whether bar code information has been able to be read normally in a scanning cycle unit, in association with the plurality of locations and information on a condition set upon reading; a determining unit that determines, based on stored reading result information which is obtained in an immediately previous scanning cycle, whether bar code information in an identical relative location in the immediately previous scanning cycle has been able to be read normally; and a condition setting unit that reads, when the determining unit determines that bar code information has been able to be read normally, information on a condition set upon reading in the immediately previous scanning cycle, and sets, when the determining unit determines that bar code information has not been able to be read normally, information on a condition that differs from information on a condition set upon reading in the immediately previous scanning cycle.

Moreover, the bar code reading apparatus according to a second aspect of the present invention, in the first aspect, the information on a condition includes a gain value set by an amplifier circuit that amplifies the received-light signal, and in a first scanning cycle after a start of scanning, the condition setting unit calculates a new gain value based on an immediately previously stored gain value and amount of received light which are obtained when scanning is performed at another location; and in a subsequent scanning cycle, the condition setting unit reads, when the determining unit determines that bar code information has been able to be read normally, a gain value in an identical relative location in an immediately previous scanning cycle, and calculates, when the determining unit determines that bar code information has not been able to be read normally, a new gain value based on an immediately previously stored gain value and amount of received light which are obtained when scanning is performed at another location.

Moreover, the bar code reading apparatus according to a third aspect of the present invention, in the first aspect, the information on a condition includes a gain value set by an amplifier circuit that amplifies the received-light signal, the bar code reading apparatus further includes a gain value storage unit that stores a predetermined number of gain values to be set, and the condition setting unit reads, when the determining unit determines that bar code information has been able to be read normally a same gain value as that used to read the bar code information, in scanning at a next location, and sets, when the determining unit determines that bar code information has not been able to be read normally, a gain value by cyclically changing the stored gain values.

Next, in order to achieve the above object, the bar code reading method according to a fourth aspect of the present invention includes: a light-emitting element that emits light; a mirror mechanism that changes an emission direction of the light emitted from the light-emitting element so that the light can cyclically scan a bar code at a plurality of different locations, with certain regularity; and a light-receiving element that receives reflected light from the bar code, and obtaining bar code information based on a received-light signal obtained by photoelectrically converting reflected light for each scanning line received by the light-receiving element, the method includes: storing reading result information about whether bar code information has been able to be read normally in a scanning cycle unit, in association with the plurality of locations and information on a condition set upon reading; determining, based on stored reading result information which is obtained in an immediately previous scanning cycle, whether bar code information in an identical relative location in the immediately previous scanning cycle has been able to be read normally; and reading, when it is determined that bar code information has been able to be read normally, information on a condition set upon reading in the immediately previous scanning cycle, and setting, when it is determined that bar code information has not been able to be read normally, information on a condition that differs from information on a condition set upon reading in the immediately previous scanning cycle.

Moreover, the bar code reading method according to a fifth aspect of the present invention, in the fourth aspect, the information on a condition includes a gain value set by an amplifier circuit that amplifies the received-light signal, and the method further includes: in a first scanning cycle after a start of scanning, calculating a new gain value based on an immediately previously stored gain value and amount of received light which are obtained when scanning is performed at another location; and in a subsequent scanning cycle, when it is determined that bar code information has been able to be read normally, reading a gain value in an identical relative location in an immediately previous scanning cycle, and when it is determined that bar code information has not been able to be read normally, calculating a new gain value based on an immediately previously stored gain value and amount of received light which are obtained when scanning is performed at another location.

Moreover, the bar code reading method according to a sixth aspect of the present invention, in the fourth aspect, the information on a condition includes a gain value set by an amplifier circuit that amplifies the received-light signal, and the method further includes: storing a predetermined number of gain values to be set; and when it is determined that bar code information has been able to be read normally, reading a same gain value as that used to read the bar code information, in scanning at a next location, and when it is determined that bar code information has not been able to be read normally, setting a gain value by cyclically changing the stored gain values.

In the first and fourth aspects of the present invention, a bar code reading apparatus includes: a light-emitting element that emits light; a mirror mechanism that changes an emission direction of the light emitted from the light-emitting element so that the light can cyclically scan a bar code at a plurality of different locations, with certain regularity; and a light-receiving element that receives reflected light from the bar code. Bar code information is obtained based on a received-light signal obtained by photoelectrically converting reflected light for each scanning line received by the light-receiving element. Reading result information about whether bar code information has been able to be read normally in a scanning cycle unit is stored in association with the plurality of locations and information on a condition set upon reading. Based on stored reading result information which is obtained in an immediately previous scanning cycle, it is determined whether bar code information in an identical relative location in the immediately previous scanning cycle has been able to be read normally. If bar code information has been able to be read normally, then information on a condition set upon reading in the immediately previous scanning cycle is maintained. If bar code information has not been able to be read normally, then information on a condition set upon reading in the immediately previous scanning cycle is changed. By cyclically scanning a bar code at a plurality of different locations, with certain regularity, when bar code information has been able to be read normally in an immediately previous scanning cycle, bar code information is read using a condition set upon reading as it is, and when bar code information has not been able to be read normally in an immediately previous scanning cycle, a condition set upon reading can be changed to a different condition. Thus, the condition can promptly converge to an appropriate condition for reading bar code information. Accordingly, for example, even when a bar code is affixed to a cylindrical to-be-detected object or when only some of scanning lines hit a bar code area, information on an appropriate condition can be promptly identified, enabling to stably read bar code information.

In the second and fifth aspects of the present invention, the information on a condition includes a gain value set by an amplifier circuit that amplifies the received-light signal, and in a first scanning cycle after a start of scanning, a new gain value is calculated based on an immediately previously stored gain value and amount of received light which are obtained when scanning is performed at another location. In a subsequent scanning cycle, when bar code information has been able to be read normally, a gain value in an identical relative location in an immediately previous scanning cycle is read, and when bar code information has not been able to be read normally, a new gain value is calculated based on an immediately previously stored gain value and amount of received light which are obtained when scanning is performed at another location. By this, a new gain value can be calculated only for a location at which bar code information has not been able to be read normally in an immediately previous scanning cycle, based on a stored gain value and an amount of received light obtained when scanning is performed at an immediately previous location; accordingly, a gain value can be promptly stabilized.

In the third and sixth aspects of the present invention, the information on a condition includes a gain value set by an amplifier circuit that amplifies the received-light signal, and a predetermined number of gain values to be set are stored. When bar code information has been able to be read normally, a same gain value as that used to read the bar code information is read in scanning at a next location, and when bar code information has not been able to be read normally, a gain value is set by cyclically changing the stored gain values. By this, every time bar code information has not been able to be read normally, a gain value does not need to be calculated and by repeatedly performing scanning until an appropriate gain value is obtained, a gain value can be promptly stabilized.

According to the above-described configuration, by cyclically scanning a bar code at a plurality of different locations, with certain regularity, when bar code information has been able to be read normally in an immediately previous scanning cycle, bar code information is read using a condition set upon reading, as it is, and when bar code information has not been able to be read normally in an immediately previous scanning cycle, a condition set upon reading can be changed to a different condition. Thus, the condition can promptly converge to an appropriate condition for reading bar code information. Accordingly, for example, even when a bar code is affixed to a cylindrical to-be-detected object or when only some of scanning lines hit a bar code area, information on an appropriate condition can be promptly identified, enabling to stably read bar code information.

### BRIEF DESCRIPTION OF THE DRAWINGS

FIG. 1 is a block diagram schematically showing a configuration of a bar code reading apparatus according to a first embodiment of the present invention;

FIG. 2 is a schematic diagram showing a mounting state of a polygon mirror of the bar code reading apparatus according to the first embodiment of the present invention;

FIG. 3 is a block diagram showing a configuration of a control apparatus of the bar code reading apparatus according to the first embodiment of the present invention;

FIG. 4 is an illustrative diagram showing a relationship between an amount of light received by a light-receiving element and a gain value, for each scanning line;

FIG. 5 is a schematic diagram showing a case in which a bar code is affixed to a cylindrical to-be-detected object;

FIG. 6 is an illustrative diagram showing a case in which scanning lines only hit part of a bar code;

FIG. 7 is an illustrative diagram of gain value calculation based on a result of an immediately previous reading process at another scanning line;

FIG. 8 is a flowchart showing steps of a gain value modification process performed by a CPU of the control apparatus of the bar code reading apparatus according to the first embodiment of the present invention;

FIG. 9 is a schematic diagram showing steps of a gain value modification process according to the first embodiment of the present invention;

FIG. 10 is an illustrative diagram of gain value calculation for when a gain value modification process according to the first embodiment of the present invention is repeatedly performed on eight scanning lines;

FIG. 11 is a flowchart showing steps of a gain value modification process performed by a CPU of a control apparatus of a bar code reading apparatus according to a second embodiment of the present invention;

FIG. 12 is an illustrative diagram of gain value candidates stored in a RAM;

FIG. 13 is a schematic diagram showing steps of a gain value modification process according to the second embodiment of the present invention; and

FIG. 14 is an illustrative diagram of gain value calculation for when a gain value modification process according to the second embodiment of the present invention is repeatedly performed on eight scanning lines.

### DESCRIPTION OF THE PREFERRED EMBODIMENTS

Bar code reading apparatuses according to embodiments of the present invention will be described below with reference to the drawings. Note that elements having the same or like configurations or functions are denoted by the same or like reference numerals throughout the drawings to be referred to and overlapping description thereof is not given.

### First Embodiment

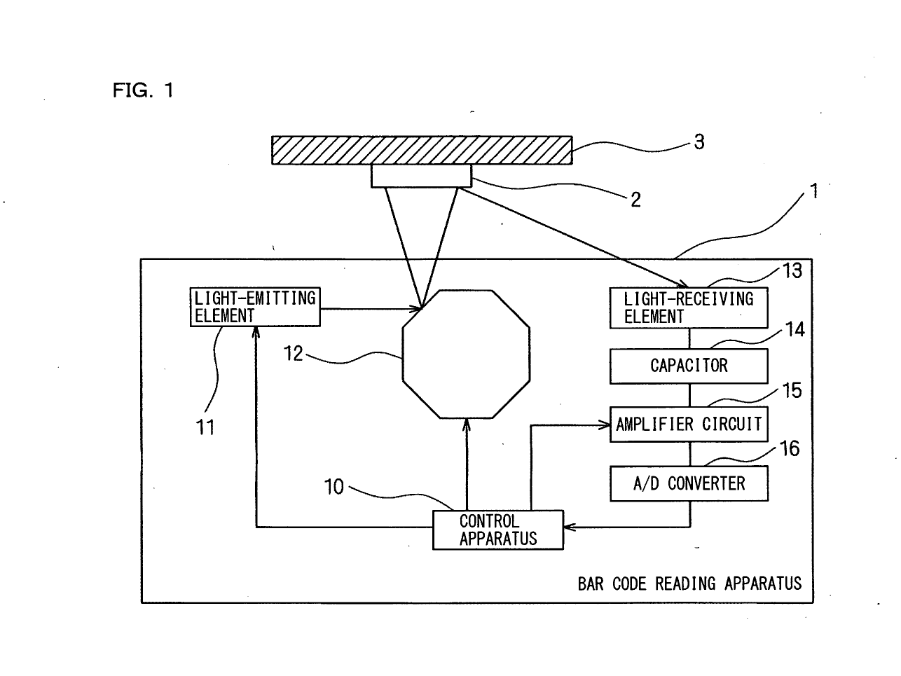

FIG. 1 is a block diagram schematically showing a configuration of a bar code reading apparatus according to a first embodiment of the present invention. As shown in FIG. 1, in a bar code reading apparatus 1 according to the first embodiment, light is emitted from a light-emitting element 11, such as semiconductor laser or an LED, and the light is reflected off a surface of a polygon mirror 12 which is a mirror mechanism, toward a to-be-detected object 3.

The reflected light that is reflected off the polygon mirror 12 is guided to a bar code 2 affixed to the to-be-detected object 3. A light-receiving element 13, such as a CCD or a photodiode, receives reflected light from the bar code 2 and outputs a received-light signal obtained by photoelectrically converting the received reflected light. A direct-current component of the received-light signal is eliminated by a capacitor 14, the resulting received-light signal is amplified according to a gain value set by an amplifier circuit 15, and the amplified received-light signal is converted into a digital signal by an A/D converter 16, and thereafter, the digital signal is inputted to a control apparatus 10.

The control apparatus 10 synchronizes emission timing of the light-emitting element 11 and the number of rotations of the polygon mirror 12 and controls a width of light emitted to the to-be-detected object 3 and timing. A gain value of the amplifier circuit 15 is set by a method which will be described later, when bar code information provided by the bar code 2 is decoded.

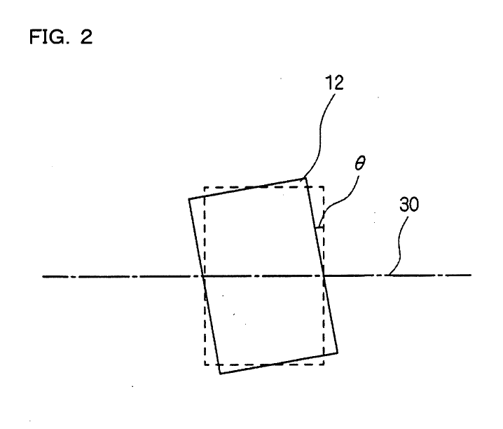

FIG. 2 is a schematic diagram showing a mounting state of the polygon mirror 12 of the bar code reading apparatus 1 according to the first embodiment of the present invention. As shown in FIG. 2, the polygon mirror 12 according to the first embodiment is mounted to be tilted by a predetermined angle θ relative to a rotating shaft 30. When the polygon mirror 12 is rotated by rotation of the rotating shaft 30, the angle of incidence of light emitted from the light-emitting element 11 varies between surfaces of the polygon mirror 12 and thus scanning can be cyclically performed with certain regularity along a plurality of different scanning lines.

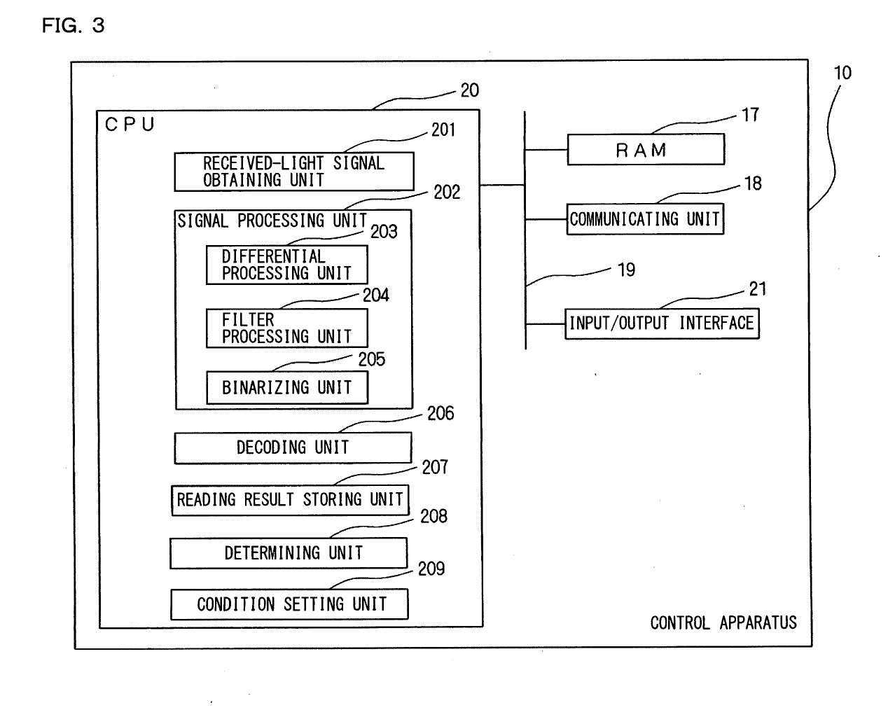

FIG. 3 is a block diagram showing a configuration of the control apparatus 10 of the bar code reading apparatus 1 according to the first embodiment of the present invention. As shown in FIG. 3, the control apparatus 10 of the bar code reading apparatus 1 according to the present embodiment includes at least a CPU (Central Processing Unit) 20, a RAM 17, a communicating unit 18, and an internal bus 19 that connects the aforementioned hardware. The CPU 20 is connected to hardware units of the control apparatus 10, such as those described above, via the internal bus 19 and controls the operations of the hardware units and performs various software functions, according to a computer program stored in the RAM 17. The RAM 17 is configured by a volatile memory such as an SRAM or SDRAM. When a computer program is executed, a load module is decompressed and temporary data and the like, generated when the computer program is executed are stored in the RAM 17. For example, the RAM 17 stores read data (an amount of received light, an amount of light, a gain value, and the like) for each scanning line at which a reading process of the bar code 2 is performed.

The communicating unit 18 is connected to the internal bus 19 and is connected to the light-emitting element 11, a rotation driving unit of the polygon mirror 12, the amplifier circuit 15, and the like, through communication lines and sends out an on/off signal of the light-emitting element 11, an instruction signal for a rotation speed, etc., of the polygon mirror 12, an instruction signal for a gain value, and the like. Also, by connecting the communicating unit 18 to an external network such as the Internet, a LAN, or a WAN, the communicating unit 18 can perform data transmission and reception with an external computer, or the like. Note that a computer program stored in the RAM 17 is a computer program downloaded from an external computer through the communicating unit 18.

The CPU 20 of the control apparatus 10 includes a received-light signal obtaining unit 201, a signal processing unit 202 including a differential processing unit 203, a filter processing unit 204, and a binarizing unit 205, a decoding unit 206, a reading result storing unit 207, a determining unit 208, and a condition setting unit 209, and controls processing operations thereof.

The received-light signal obtaining unit 201 obtains a received-light signal as a digital signal, which is received by the communicating unit 18. Specifically, light reflected off the bar code 2 is received by the light-receiving element 13, such as a CCD or a photodiode, and the received light is photoelectrically converted. A direct-current component of the photoelectrically converted analog signal is eliminated by the capacitor 14, the resulting analog signal is amplified according to a gain value set by the amplifier circuit 15, and the amplified analog signal is converted into a digital signal by the A/D converter 16. The received-light signal obtaining unit 201 obtains the digital signal.

The signal processing unit 202 preprocesses the obtained received-light signal which is a digital signal, into a signal in a decodable state. The differential processing unit 203 in the signal processing unit 202 performs a differential process on the obtained received-light signal and thereby extracts an edge portion of the received-light signal.

The filter processing unit 204 is a band-pass filter that allows only those signals that are present in a specific frequency band to pass therethrough. The binarizing unit 205 performs the following process on signals in the frequency band limited by the filter processing unit 204. Specifically, the binarizing unit 205 brings a signal larger than a predetermined threshold value into an on state and brings a signal smaller than the predetermined threshold value into an off state and thereby converts the signals into pulse signals.

The decoding unit 206 reads content of the signals converted into pulse signals by the signal processing unit 202. Specifically, the decoding unit 206 reads information indicating a start point and an end point of the bar code 2, parity information, and the like, and reads bar code information and outputs and stores those information in the RAM 17. If the decoding unit 206 has not been able to read bar code information, the decoding unit 206 outputs information indicating such a fact and stores the information in the RAM 17.

The reading result storing unit 207 stores in the RAM 17 reading result information about whether, when scanning is cyclically performed with certain regularity along a plurality of different scanning lines (locations), the decoding unit 206 has been able to normally read bar code information in a cycle unit, in association with information on a condition set upon reading, and the plurality of scanning lines. Accordingly, information about which scanning lines bar code information has been able to be read normally at and which scanning lines bar code information has not been able to be read normally at for which cycles of scanning can be stored in association with information on a condition, as history information. Note that the information on a condition refers to, for example, overall information such as a gain value that is set for the amplifier circuit 15.

The determining unit 208 determines, based on reading result information which is obtained in an immediately previous scanning cycle and stored in the RAM 17 by the reading result storing unit 207, whether bar code information for a scanning line in an identical relative location in the immediately previous scanning cycle has been able to be read normally. For example, in a case of reading bar code information at an nth (n is a natural number) scanning line, it is determined whether bar code information has been able to be read normally at the nth (n is a natural number) scanning line in the last scanning cycle.

If the determining unit 208 determines that bar code information has been able to be read normally in the last scanning cycle, then the condition setting unit 209 reads information on a condition set upon reading in the last scanning cycle. If the determining unit 208 determines that bar code information has not been able to be read normally, then the condition setting unit 209 sets information on a new condition, based on information on a condition and an amount of received light set upon immediately previous reading. Namely, information on a new condition, e.g., a new gain value, is set only for those scanning lines at which bar code information has not been able to be read normally.

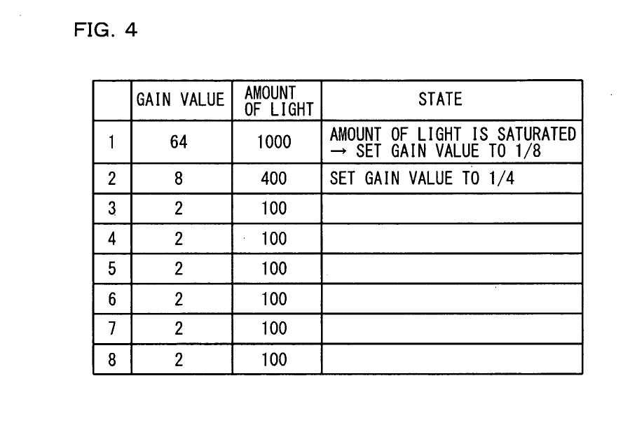

Conventionally, a gain value of the amplifier circuit 15 is set for each scanning line and the control apparatus 10 receives, as an amount of light, a value obtained by multiplying an amount of light received by the light-receiving element 13 by a gain value. FIG. 4 is an illustrative diagram showing a relationship between an amount of light received by the light-receiving element 13 and a gain value, for each scanning line. An example of FIG. 4 shows that the amounts of light for scanning lines #1 and #2 are larger than those for other scanning lines, and for the scanning line #1 the amount of light exceeds a maximum amount of light and thus is saturated.

In this case, to substantially uniformalize amounts of light between scanning lines, gain values for the scanning lines #1 and #2 should be reduced. Particularly, for the scanning line #2, it is apparent that by setting the gain value to one-quarter of its original gain value, the amount of light matches those for other scanning lines. On the other hand, for the scanning line #1, by tentatively setting the gain value to one-eighth of its original gain value, the amount of light can approximate those for other scanning lines.

Such a gain value adjustment method is premised on that the amount of light is constant from the start of a reading process of the bar code 2 until the setting of a gain value is completed. However, in practice, there may be many situations where the amount of light is not constant from the start of a reading process of the bar code 2 until the setting of a gain value is completed.

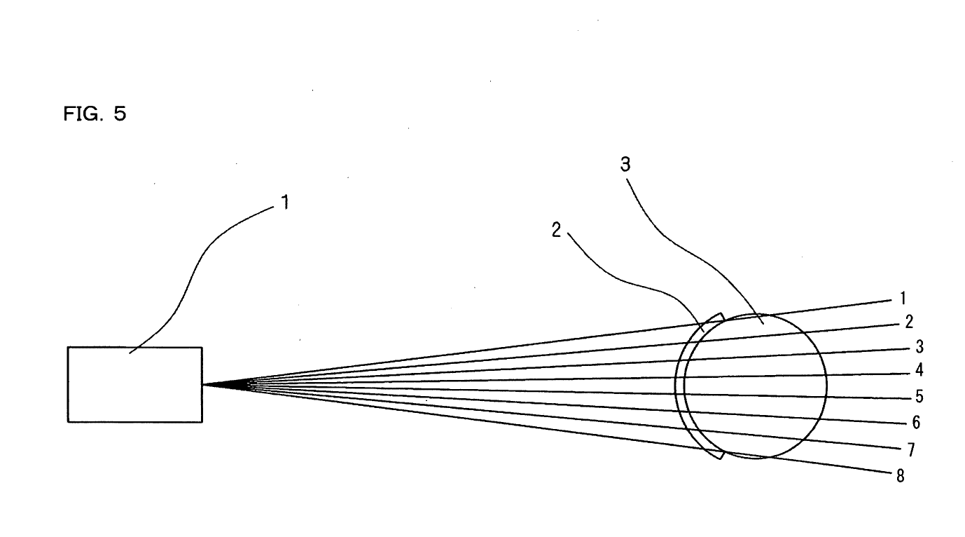

FIG. 5 is a schematic diagram showing a case in which a bar code 2 is affixed to a cylindrical to-be-detected object 3. In FIG. 5, the cylindrical to-be-detected object 3 is assumed to be a test tube, or the like. As shown in FIG. 5, when a straight line distance between the bar code reading apparatus 1 and the to-be-detected object 3 having the bar code 2 affixed thereto varies between scanning lines, scanning lines #4 and #5 that hit near a center of the to-be-detected object (test tube) 3 have large amounts of reflected light because reflection is close to regular reflection; on the other hand, scanning lines #1 and #8 that are away from the center of the to-be-detected object (test tube) 3 have relatively small amounts of light because the distance from the bar code reading apparatus 1 is far and reflected light is easily diffused.

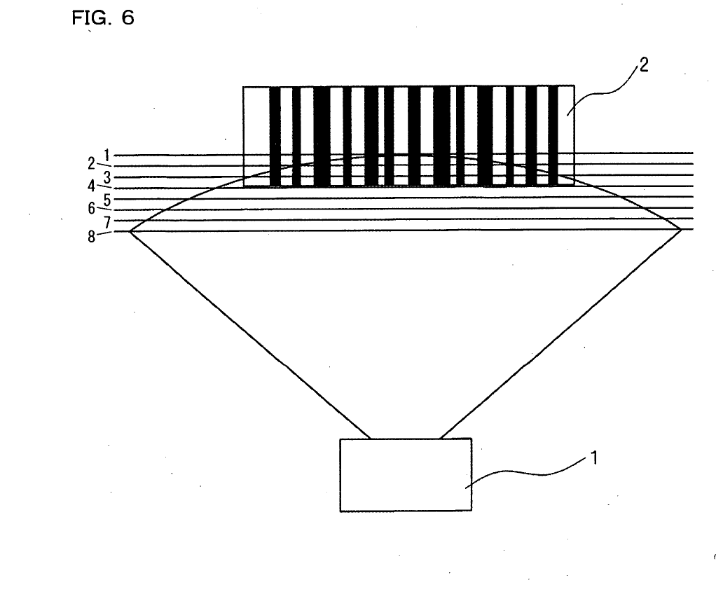

FIG. 6 is an illustrative diagram showing a case in which scanning lines only hit part of a bar code 2. As shown in FIG. 6, while scanning lines #1 to #3 are present on the bar code 2, scanning lines #4 to #8 do not directly hit the bar code 2. Therefore, the scanning lines #4 to #8 go into a strong regular reflection state, as with a case of scanning white paper, and thus have large amounts of reflected light.

In these cases, the amount of light varies depending on the location of a scanning line, from the start of a reading process of the bar code 2 until the setting of a gain value is completed and thus gain values cannot be uniformly set. In view of this, when bar code reading is performed on a plurality of scanning lines in turn, it is common practice to determine a gain value, based on the amount of reflected light for a scanning line at which a reading process is performed immediately previously and a set gain value.

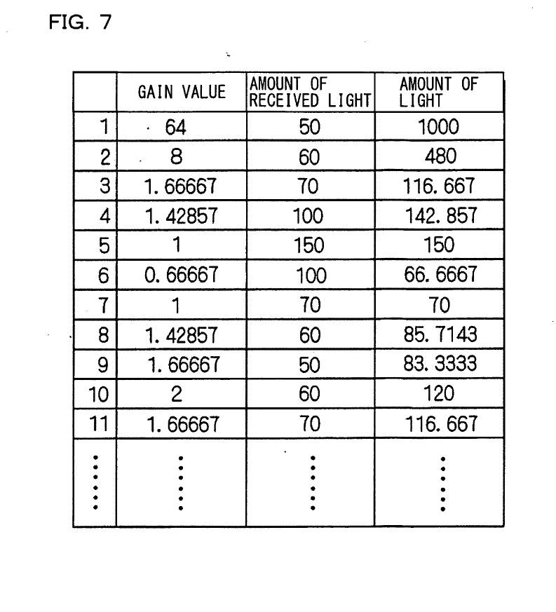

FIG. 7 is an illustrative diagram of gain value calculation based on a result of an immediately previous reading process at another scanning line. In FIG. 7, a case is described in which, for example, the amounts of received reflected light for scanning lines #1 to #8 are respectively 50, 60, 70, 100, 150, 100, 70, and 60. The numbers 1 to 8 in FIG. 7 respectively represent results of a reading process for the scanning lines #1 to #8 for first sequential reading. For example, in the scanning line #1, the gain value is “64” and the amount of light is a saturation amount of light that exceeds “1000”. Hence, in the scanning line #2, the gain value is uniformly set to “8” which is one-eighth of the gain value used upon a reading process at the scanning line #1, and the amount of light “480” is obtained.

Then, in the scanning line #3, by using the last gain value, i.e., the gain value “8” used upon a reading process at the scanning line #2, and an amount of light obtained upon an immediately previous reading process, i.e., the amount of light “480” which is a result of the reading process at the scanning line #2, a correction is made to obtain an amount of light of “100”. That is, the gain value for the scanning line #3 obtains: 8×100/480=“1.66667”.

Thereafter, based on a gain value used upon an immediately previous reading process and an amount of light which is a result of the reading process, a gain value to be set upon a reading process is sequentially set and an amount of light which is a result of the reading process is calculated for each scanning line.

For scanning lines #9 to #11 respectively focusing on the scanning lines #1 to #3, the scanning lines #9 and #10 respectively show results of a reading process where the gain values for the scanning lines #1 and #2 are modified, and the scanning line #11 shows a result of a reading process where reading is performed at the scanning line #3 using an original gain value.

In an example of FIG. 7, however, since a gain value is continuously modified with reference to a gain value and an amount of light that are obtained at the time when an immediately previous reading process is performed at another scanning line, a gain value for a scanning line at which bar code information has already been able to be normally read is also modified with reference to a gain value and an amount of light obtained at the time when an immediately previous reading process is performed. Consequently, because a gain value that does not originally need to be modified is also modified indiscriminately, it requires a considerable amount of time for gain values to converge within a certain range, causing a problem that it takes time to stably read a bar code 2.

In view of this, in the first embodiment, although a point that a reading process is performed at each scanning line is the same, a determination as to whether bar code information has been able to be read normally is made for each scanning line and only when bar code information has not been able to be read normally, a gain value is set based on a gain value and an amount of light (a value obtained by multiplying an amount of received light by a gain value) which are obtained at the time when an immediately previous reading process is performed at another scanning line.

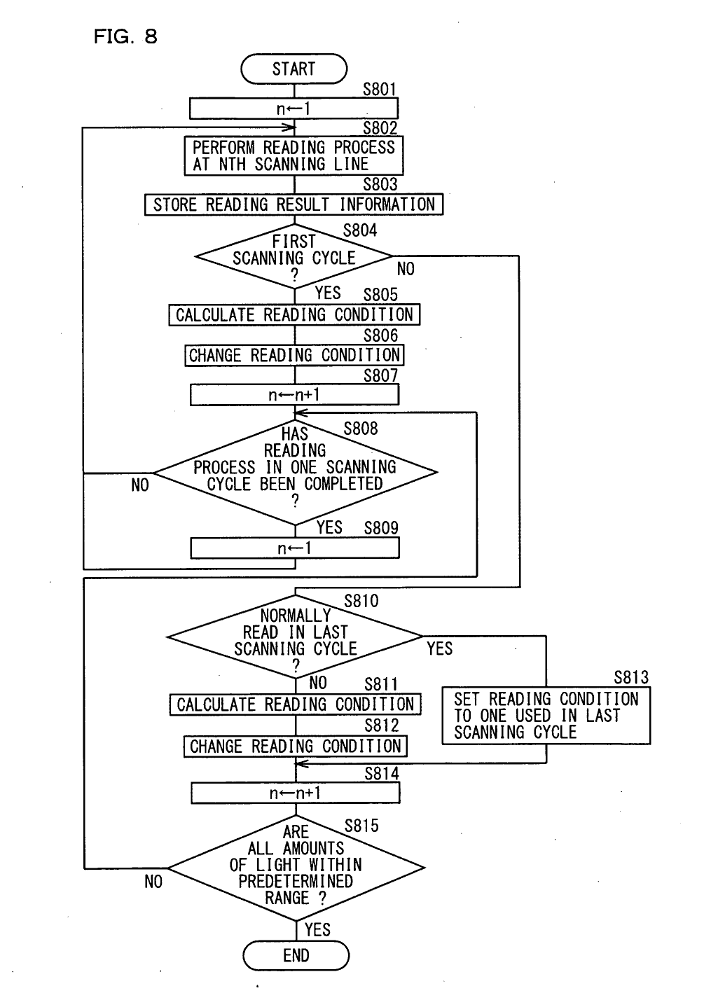

FIG. 8 is a flowchart showing steps of a gain value modification process performed by the CPU 20 of the control apparatus 10 of the bar code reading apparatus 1 according to the first embodiment of the present invention. In an example of FIG. 8, for simplification of description, when bar code information has not been able to be read normally at an immediately previous scanning line, a gain value is updated to a value that is one-half of a gain value set upon a reading process at the immediately previous scanning line. In FIG. 8, the CPU 20 of the control apparatus 10 sets a counter n to an initial value “1” (step S801), performs a reading process of a bar code 2 at an nth scanning line (step S802), and stores in the RAM 17 information on whether bar code information has been able to be read normally, as reading result information which is a result of the reading process, an amount of light received by the CPU 20 (an amount of light received by the light-receiving element 13× a gain value), and a gain value (step S803).

Note that a method of determining whether bar code information has been able to be read normally is not particularly limited. In the first embodiment, such a determination is made based on whether the amount of light received by the CPU 20 is greater than 100 and smaller than 600. The determination condition is, of course, not limited thereto.

The CPU 20 determines whether the current reading process is a reading process in a first scanning cycle (step S804). If the CPU 20 determines that the current reading process is a reading process in a first scanning cycle (YES in step S804), then the CPU 20 calculates a reading condition to be used at a next scanning line, e.g., a gain value to be set in a reading process, based on the amount of light and gain value stored in the RAM 17 (step S805). The CPU 20 changes the reading condition to the calculated new reading condition (step S806). The reading condition may, of course, be the same as the last one, depending on the result of a reading process.

The CPU 20 increments the counter n by “1” (step S807) and determines whether a reading process in one scanning cycle has been completed (step S808). If the CPU 20 determines that a reading process in one scanning cycle has not been completed (NO in step S808), then the CPU 20 returns processing to step S802 and repeats the above-described process.

If the CPU 20 determines that a reading process in one scanning cycle has been completed (YES in step S808), then the CPU 20 re-sets the counter n to the initial value “1” (step S809) and returns processing to step S802 and repeats the above-described process.

If the CPU 20 determines that the current reading process is not a reading process in a first scanning cycle (NO in step S804), then the CPU 20 determines whether bar code information has been able to be read normally in a reading process at an nth scanning line in the last scanning cycle (step S810). Specifically, if information indicating a start point and an end point of the bar code 2, parity information, read bar code information, and the like, which are outputted from the decoding unit 206 are stored in the RAM 17, then it is determined that bar code information has been able to be read normally. If information indicating that bar code information has not been able to be read is stored in the RAM 17, then it is determined that bar code information has not been able to be read normally.

If the CPU 20 determines that bar code information has not been able to be read normally in a reading process at an nth scanning line in the last scanning cycle (NO in step S810), then the CPU 20 calculates a reading condition to be used at a next scanning line, e.g., a gain value to be set in a reading process, based on the amount of light and gain value stored in the RAM 17 (step S811). The CPU 20 changes the reading condition to the calculated new reading condition (step S812). The reading condition may, of course, be the same as the last one, depending on the result of a reading process.

If the CPU 20 determines that bar code information has been able to be read normally in a reading process at an nth scanning line in the last scanning cycle (YES in step S810), then the CPU 20 sets the reading condition to the one in the last scanning cycle (step S813) and increments the counter n by “1” (step S814). Since if the reading condition is one with which bar code information has been able to be read normally once, it is unlikely that bar code information cannot be read normally thereafter with that same reading condition, it is desirable to use, for an identical scanning line, a reading condition used upon a reading process in the last scanning cycle, as it is.

The CPU 20 determines whether amounts of light for all scanning lines have converged within a predetermined range (step S815). If the CPU 20 determines that amounts of light for all scanning lines have not converged yet (NO in step S815), then the CPU 20 returns processing to step S808 and repeats the above-described process. If the CPU 20 determines that amounts of light for all scanning lines have converged (YES in step S815), then the CPU 20 ends the process.

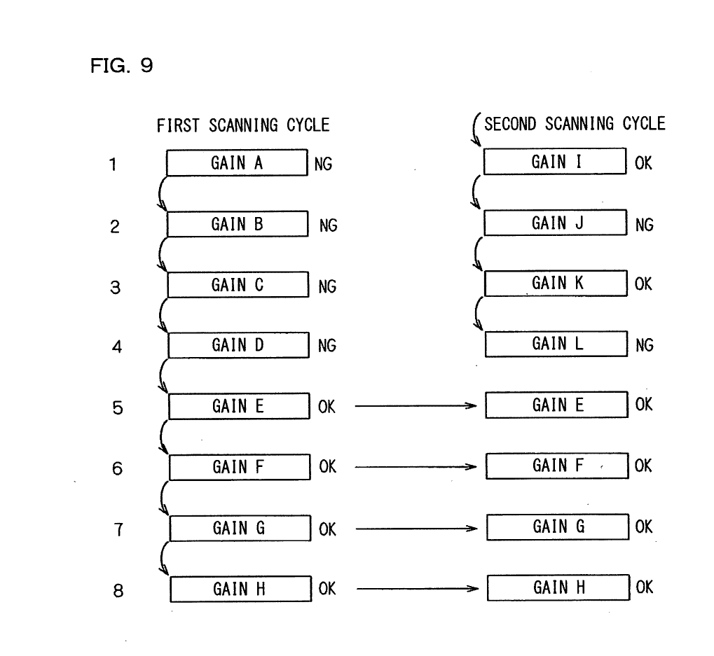

FIG. 9 is a schematic diagram showing steps of a gain value modification process according to the first embodiment of the present invention. The numbers at a far left of FIG. 9 are numbers identifying eight scanning lines; specifically, the numbers indicate, from the top, scanning lines #1, #2, . . . #8.

In an example of FIG. 9, in a first scanning cycle, for the scanning lines #1 to #8, a new gain value is sequentially calculated based on an amount of light and a gain value for an immediately previous scanning line. Specifically, when the scanning line #1 has a gain A, a gain B calculated based on the gain A and an amount of light for the scanning line #1 is set for the scanning line #2 and a gain C calculated based on the gain B and an amount of light for the scanning line #2 is set for the scanning line #3, and thereafter, a gain value is sequentially calculated until a gain H is set for the scanning line #8.

Also, reading result information about whether bar code information has been able to be read normally with a calculated gain value is stored in the RAM 17. In the example of FIG. 9, “OK” indicates that bar code information has been able to be read normally and “NG” indicates that bar code information has not been able to be read normally. In the example of FIG. 9, in the first scanning cycle, although bar code information has not been able to be read normally at the scanning lines #1 to #4, bar code information has been able to be read normally at the scanning lines #5 to #8.

In a second scanning cycle, a determination as to whether to calculate a gain value for an identical scanning line is made based on reading result information obtained in the last scanning cycle. Specifically, for those scanning lines with “OK” in the first scanning cycle, gain values set in the first scanning cycle are not changed; on the other hand, for those scanning lines with “NG” in the first scanning cycle, a new gain value is calculated by the same method as that used for calculation in the first scanning cycle, based on an amount of light and a gain value for an immediately previous scanning line.

In the example of FIG. 9, for the scanning line #1, since bar code information has not been able to be read normally in the first scanning cycle, a gain value is calculated based on an amount of light and a gain value for the scanning line #8 in the first scanning cycle, which is an immediately previous scanning line. That is, a gain value is set to a gain I, independently of the gain A which is a gain value used in the first scanning cycle. Similarly, for the scanning line #2, too, since bar code information has not been able to be read normally in the first scanning cycle, a gain value is calculated to be a gain J, based on an amount of light and a gain value for the scanning line #1 in the second scanning cycle, which is an immediately previous scanning line. Thereafter, similarly, for scanning lines up to #4, since bar code information has not been able to be read normally in the first scanning cycle, a gain value is calculated based on an amount of light and a gain value for an immediately previous scanning line.

For the scanning line #5, since bar code information has been able to be read normally in the first scanning cycle, the gain value is maintained as it is, i.e., a gain E which is a gain value used in the first scanning cycle. Thereafter, similarly, for the scanning lines #6 to #8, since bar code information has been able to be read normally in the first scanning cycle, the gain values are maintained as gains F, G, and H, respectively, which are gain values used in the first scanning cycle.

When, in the second scanning cycle, bar code information has been able to be read normally at all scanning lines, i.e., when all of the scanning lines #1 to #8 obtain “OK”, in and after a third scanning cycle, bar code information is read with gain values set for all scanning lines being maintained. When there is a scanning line with “NG”, a new gain value is calculated by the same method as that described above, in and after the third scanning cycle, as well.

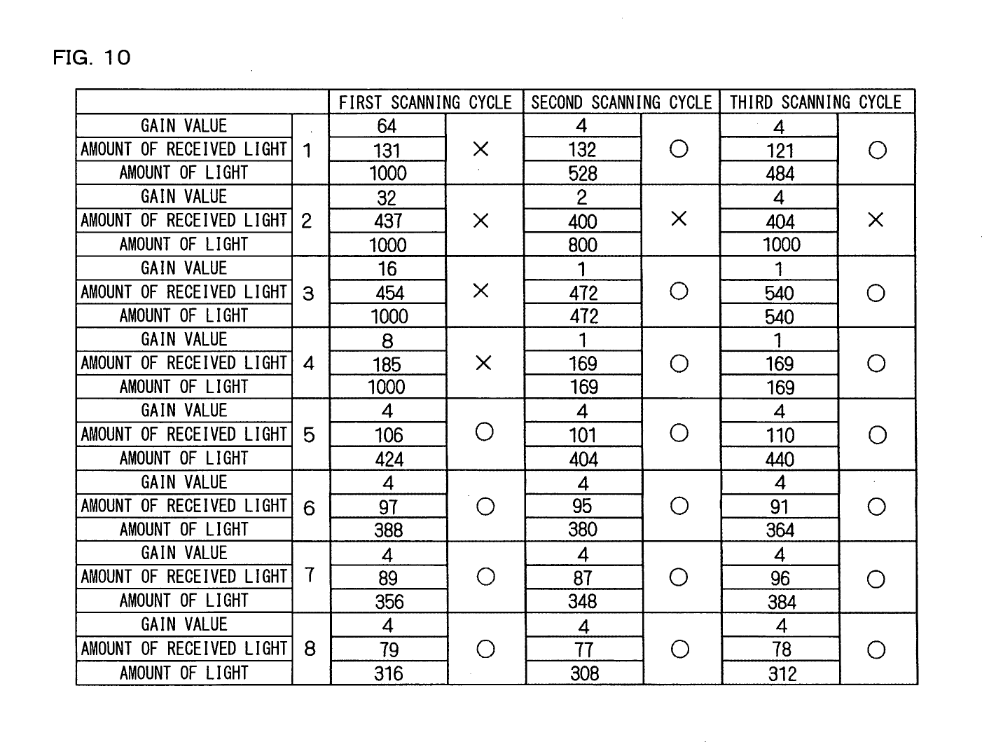

Specific exemplary gain value calculation is shown below. FIG. 10 is an illustrative diagram of gain value calculation for when a gain value modification process according to the first embodiment of the present invention shown in FIG. 8 is repeatedly performed on eight scanning lines. The numbers in a far left column of FIG. 10 are numbers identifying eight scanning lines; specifically, the numbers indicate, from the top, scanning lines #1, #2, . . . #8.

In an example of FIG. 10, a gain value is set under rules where an initial value is “64” and when an amount of light (an amount of received light× a gain value) for a scanning line which is obtained last time is within a range not less than 200 and not more than 500 a gain value for the scanning line which is used last time is maintained, and when outside the range a new gain value is set by halving a gain value for the scanning line which is used last time.

For the scanning line #1 in the first scanning cycle, since the amount of light is a saturation amount of light, it can be determined that the gain value “64” which is set as a reading condition is not appropriate. Hence, “x” which is information indicating that a reading result for the scanning line #1 in the first scanning cycle has not been normal is stored in the RAM 17 as reading result information, and using the gain value “64” for the scanning line #1, the gain value “32” (=64×½) is obtained as a gain value for the scanning line #2. Note that whether a reading result is normal is determined based on whether the amount of light is within the range of not less than 100 and not more than 600.

Thereafter, for scanning lines up to #4 in the first scanning cycle, since the amount of light is a saturation amount of light, “x” which is information indicating that a reading result for each scanning line in the first scanning cycle has not been normal is stored in the RAM 17 as reading result information, and a new gain value obtained by halving a gain value for an immediately previous scanning line is set as a gain value for each scanning line.

For the scanning line #5 in the first scanning cycle, since the amount of light is “424” and thus is within the range of not less than 200 and not more than 500, it can be determined that the gain value “4” which is set as a reading condition is appropriate. Hence, “◯” which is information indicating that a reading result for the scanning line #5 in the first scanning cycle is normal is stored in the RAM 17 as reading result information, and the gain value “4” for the scanning line #5 is set as it is as a gain value for the scanning line #6.

Thereafter, similarly, for the first scanning cycle, a gain value as a reading condition to be used is set based on an immediately previous gain value and amount of light. This is because in the first scanning cycle, a gain value which is a reading condition used last time is not calculated for each scanning line.

Then, for the scanning line #1 in a second scanning cycle, “x” which is information indicating that a reading result in the first scanning cycle has not been normal is read from reading result information stored in the RAM 17. Hence, as in the first scanning cycle, a gain value as a reading condition to be used is set based on an immediately previous gain value and amount of light.

Specifically, for the scanning line #1 in the second scanning cycle, since the amount of light is “528” and thus is outside the range of not less than 200 and not more than 500, it can be determined that the gain value “4” set as a reading condition is not appropriate. Hence, “∘” is stored in the RAM 17 as information indicating that a reading result for the scanning line #1 in the second scanning cycle is normal, and a new gain value “2” obtained by halving the gain value “4” for the scanning line #1 is set as a gain value for the scanning line #2.

Then, for the scanning line #2 in the second scanning cycle, “x” which is information indicating that a reading result in the first scanning cycle has not been normal is read from reading result information stored in the RAM 17. Hence, as in the first scanning cycle, a gain value as a reading condition to be used is set based on an immediately previous gain value and amount of light.

Specifically, for the scanning line #2 in the second scanning cycle, since the amount of light is “800” and thus is outside the range of not less than 200 and not more than 500, it can be determined that the gain value “2” set as a reading condition is not appropriate. Hence, “x” is stored in the RAM 17 as information indicating that a reading result for the scanning line #2 in the second scanning cycle is not normal, and a new gain value “1” obtained by halving the gain value “2” for the scanning line #2 is set as a gain value for the scanning line #3.

Thereafter, for scanning lines up to #4 in the second scanning cycle, since “x” which is information indicating that a reading result in the first scanning cycle has not been normal is read from reading result information stored in the RAM 17, as in the first scanning cycle, a gain value as a reading condition to be used is set based on an immediately previous gain value and amount of light.

Then, for the scanning line #5 in the second scanning cycle, “◯” which is information indicating that a reading result in the first scanning cycle is normal is read from reading result information stored in the RAM 17. Hence, a gain value in the first scanning cycle is maintained as it is and thus the gain value “4” is set as a reading condition.

Thereafter, for scanning lines up to #8, since “◯” which is information indicating that a reading result in the first scanning cycle is normal is stored, the gain value “4” used in the first scanning cycle is used as it is as a gain value for each scanning line. For third and subsequent scanning cycles, too, the same process is repeated.

As described above, according to the first embodiment, for those scanning lines at which reading has been able to be performed normally ever once, reading can be continuously performed normally thereafter, and only for those scanning lines at which reading has not been able to be performed normally, a reading condition can be allowed to converge to an appropriate reading condition, and thus, total time required for reading to be stabilized can be reduced.

Moreover, even when the amount of light varies depending on the location of a scanning line from the start of a reading process of a bar code 2 until the setting of a gain value is completed and thus gain values cannot be uniformly set, e.g., when a bar code 2 is affixed to a cylindrical to-be-detected object 3 or when scanning lines only hit part of a bar code 2, a gain value or the like which is an appropriate reading condition can be promptly identified, enabling to provide a bar code reading apparatus capable of performing stable bar code reading.

### Second Embodiment

A configuration of a bar code reading apparatus according to a second embodiment of the present invention is the same as that of the first embodiment and thus the same reference numerals are provided and a detailed description thereof is not given. Although the second embodiment is the same as conventional cases in performing a reading process at each scanning line, the second embodiment is different from the first embodiment in that a determination as to whether reading has been able to be performed normally is made for each scanning line and if reading has not been able to be performed normally, then a plurality of gain values stored in advance are repeatedly set in a predetermined order.

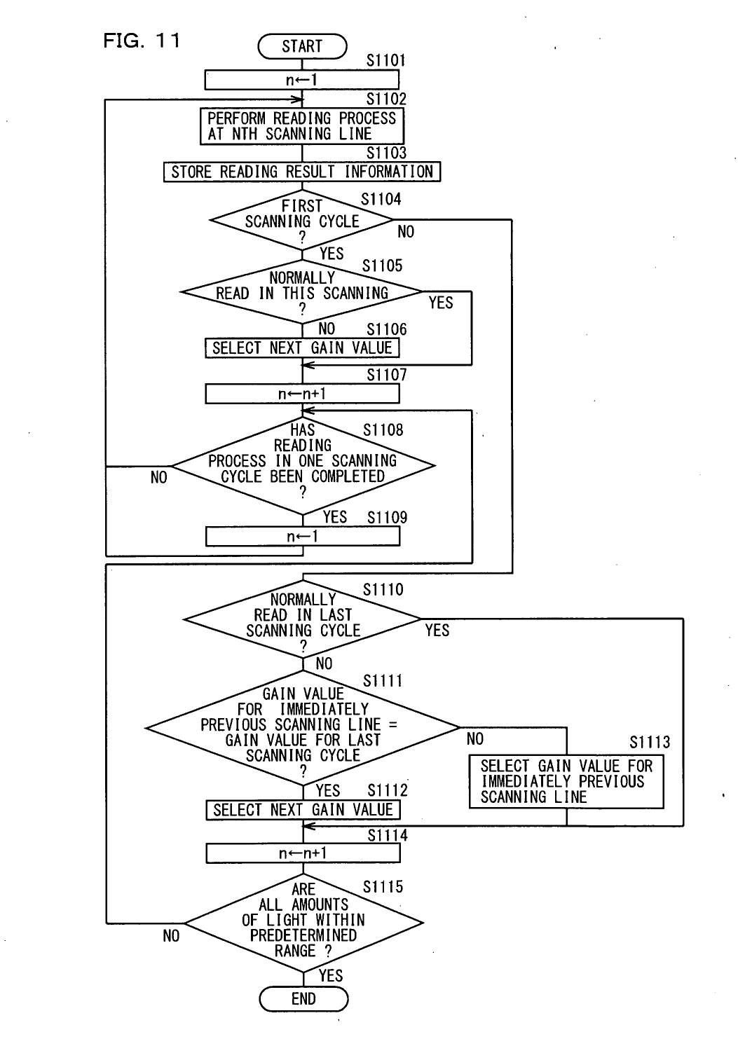

FIG. 11 is a flowchart showing steps of a gain value modification process performed by a CPU 20 of a control apparatus 10 of a bar code reading apparatus 1 according to the second embodiment of the present invention. In FIG. 11, the CPU 20 of the control apparatus 10 sets a counter n to the initial value “1” (step S1101), performs a reading process of a bar code 2 at an nth scanning line (step S1102), and stores in a RAM 17 information on whether bar code information has been able to be read normally, as reading result information which is a result of the reading process, an amount of light received by the CPU 20 (an amount of light received by a light-receiving element 13× a gain value), and a gain value (step S1103).

Note that a method of determining whether bar code information has been able to be read normally is not particularly limited. In the second embodiment, such a determination is made based on whether the amount of light received by the CPU 20 is within a range of not less than 100 and not more than 600.

The CPU 20 determines whether the current reading process is a reading process in a first scanning cycle (step S1104). If the CPU 20 determines that the current reading process is a reading process in a first scanning cycle (YES in step S1104), then the CPU 20 determines whether bar code information has been able to be read normally in this scanning (step S1105). Specifically if information indicating a start point and an end point of the bar code 2, parity information, read bar code information, and the like, which are outputted from a decoding unit 206 are stored in the RAM 17, then it is determined that bar code information has been able to be read normally. If information indicating that bar code information has not been able to be read is stored in the RAM 17, then it is determined that bar code information has not been able to be read normally.

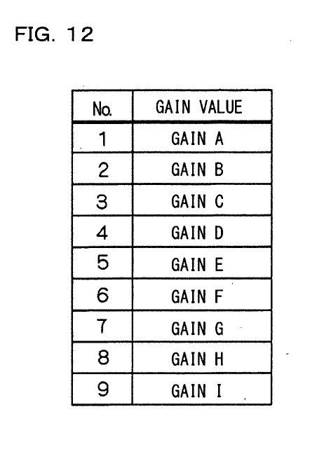

If the CPU 20 determines that bar code information has not been able to be read normally (NO in step S1105), then the CPU 20 selects a gain value to be set next, from gain value candidates stored in advance in the RAM 17 (step S1106). FIG. 12 is an illustrative diagram of the gain value candidates stored in the RAM 17. In an example of FIG. 12, nine gain values from gains A to I are stored in order from 1 to 9. The CPU 20 sequentially selects a gain value according to the order.

Returning to FIG. 11, if the CPU 20 of the control apparatus 10 determines that bar code information has been able to be read normally (YES in step S1105), then the CPU 20 determines that there is no need to change a gain value and thus skips step S1106, increments the counter n by “1” (step S1107), and determines whether a reading process in one scanning cycle has been completed (step S1108). If the CPU 20 determines that a reading process in one scanning cycle has not been completed (NO in step S1108), then the CPU 20 returns processing to step S1102 and repeats the above-described process.

If the CPU 20 determines that a reading process in one scanning cycle has been completed (YES in step S1108), then the CPU 20 re-sets the counter n to the initial value “1” (step S1109) and returns processing to step S1102 and repeats the above-described process.

If the CPU 20 determines that the current reading process is not a reading process in a first scanning cycle (NO in step S1104), then the CPU 20 determines whether bar code information has been able to be read normally in a reading process at an nth scanning line in the last scanning cycle (step S1110). Specifically if information indicating a start point and an end point of the bar code 2, parity information, read bar code information, and the like, which are outputted from the decoding unit 206 are stored in the RAM 17, then it is determined that bar code information has been able to be read normally, If information indicating that bar code information has not been able to be read is stored in the RAM 17, then it is determined that bar code information has not been able to be read normally.

If the CPU 20 determines that bar code information has not been able to be read normally in a reading process at an nth scanning line in the last scanning cycle (NO in step S1110), then the CPU 20 determines whether a gain value for an immediately previous scanning line, i.e., a gain value set in a reading process at an n−1th scanning line, is the same as a gain value set in a reading process at an nth scanning line in the last scanning cycle (step S1111). If the CPU 20 determines that they are the same (YES in step S1111), then the CPU 20 selects a gain value to be set next, from the gain value candidates stored in advance in the RAM 17 (step S1112). If the CPU 20 determines that they are not the same (NO in step S111), then the CPU 20 selects the gain value for the immediately previous scanning line, i.e., the gain value set in a reading process at the n−1th scanning line (step S1113).

If the CPU 20 determines that bar code information has been able to be read normally in a reading process at an nth scanning line in the last scanning cycle (YES in step S1110), then the CPU 20 skips steps S1111 to S1113 and increments the counter n by “1” (step S1114). The CPU 20 determines whether amounts of light for all scanning lines have converged within a predetermined range (step S1115). If the CPU 20 determines that amounts of light for all scanning lines have not converged yet (NO in step S1115), then the CPU 20 returns processing to step S1108 and repeats the above-described process. If the CPU 20 determines that amounts of light for all scanning lines have converged (YES in step S1115), then the CPU 20 ends the process.

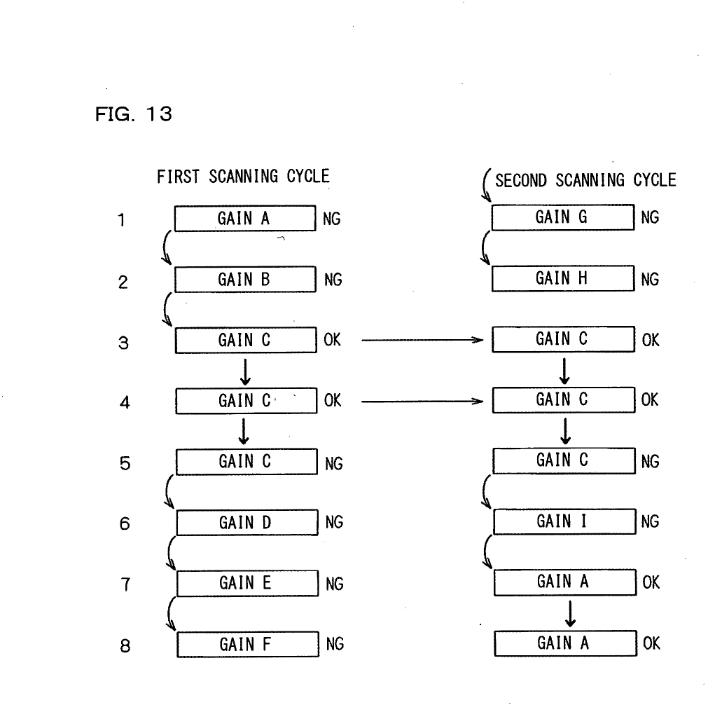

FIG. 13 is a schematic diagram showing steps of a gain value modification process according to the second embodiment of the present invention. The numbers at the far left of FIG. 13 are numbers identifying eight scanning lines; specifically, the numbers indicate, from the top, scanning lines #1, #2, . . . #8. In an example of FIG. 13, in a first scanning cycle, for the scanning lines #1 to #8, a gain value is sequentially set under predetermined rules, based on an amount of light and a gain value for an immediately previous scanning line.

First, reading result information about whether bar code information has been able to be read normally with a set gain value is stored in the RAM 17. In the example of FIG. 13, “OK” indicates that bar code information has been able to be read normally and “NG” indicates that bar code information has not been able to be read normally.

When the scanning line #1 has a gain A, in the scanning line #2, it is determined whether bar code information has been able to be read normally at the scanning line #1. If bar code information has been able to be read normally then the gain A is used as it is, and if bar code information has not been able to be read normally then the gain value is changed to a gain B which is a gain value in the next place stored in the RAM 17.

Since in the example of FIG. 13 the scanning line #1 is “NG”, in the scanning line #2 the gain value is changed to the gain B which is a gain value in the next place stored in the RAM 17. Thereafter, similarly, when bar code information has been able to be read normally at an immediately previous scanning line, i.e., when “OK”, a gain value for the immediately previous scanning line is used as it is, and when bar code information has not been able to be read normally, i.e., when “NG”, the gain value is changed to a gain value in the next place stored in the RAM 17.

In a second scanning cycle, a determination as to whether to calculate a gain value for an identical scanning line is made based on reading result information obtained in the last scanning cycle. Specifically, for those scanning lines with “OK” in the first scanning cycle, gain values set in the first scanning cycle are not changed; on the other hand, for those scanning lines with “NG” in the first scanning cycle, a new gain value is set by the same method as that used for calculation in the first scanning cycle, based on an amount of light and a gain value for an immediately previous scanning line.

In the example of FIG. 13, for the scanning line #1, since bar code information has not been able to be read normally in the first scanning cycle, a gain value is set based on an amount of light and a gain value for the scanning line #8 in the first scanning cycle, which is an immediately previous scanning line. That is, a gain value is set to a gain G, independently of the gain A which is a gain value used in the first scanning cycle. Similarly, for the scanning line #2, too, since bar code information has not been able to be read normally in the first scanning cycle, a gain value is set to a gain H, based on an amount of light and a gain value for the scanning line #1 in the second scanning cycle, which is an immediately previous scanning line.

For the scanning line #3, since bar code information has been able to be read normally in the first scanning cycle, a gain value is set to a gain C which is a gain value for the scanning line #3 in the first scanning cycle. For the scanning line #4, too, since bar code information has been able to be read normally in the first scanning cycle, a gain value is set to the gain C which is a gain value for the scanning line #4 in the first scanning cycle.

For the scanning line #5, since bar code information has not been able to be read normally in the first scanning cycle, a gain value is set based on an amount of light and a gain value for the scanning line #4 in the second scanning cycle, which is an immediately previous scanning line. That is, since bar code information has been able to be read normally at the scanning line #4 in the second scanning cycle, which is an immediately previous scanning line, independently of the gain C which is a gain value used in the first scanning cycle, a gain value is set to the gain C set for the scanning line #4 in the second scanning cycle.

Thereafter, similarly, the gain values stored in the RAM 17 are sequentially and cyclically set according to whether bar code information has been able to be read normally in the last scanning cycle and whether bar code information has been able to be read normally at an immediately previous scanning line.

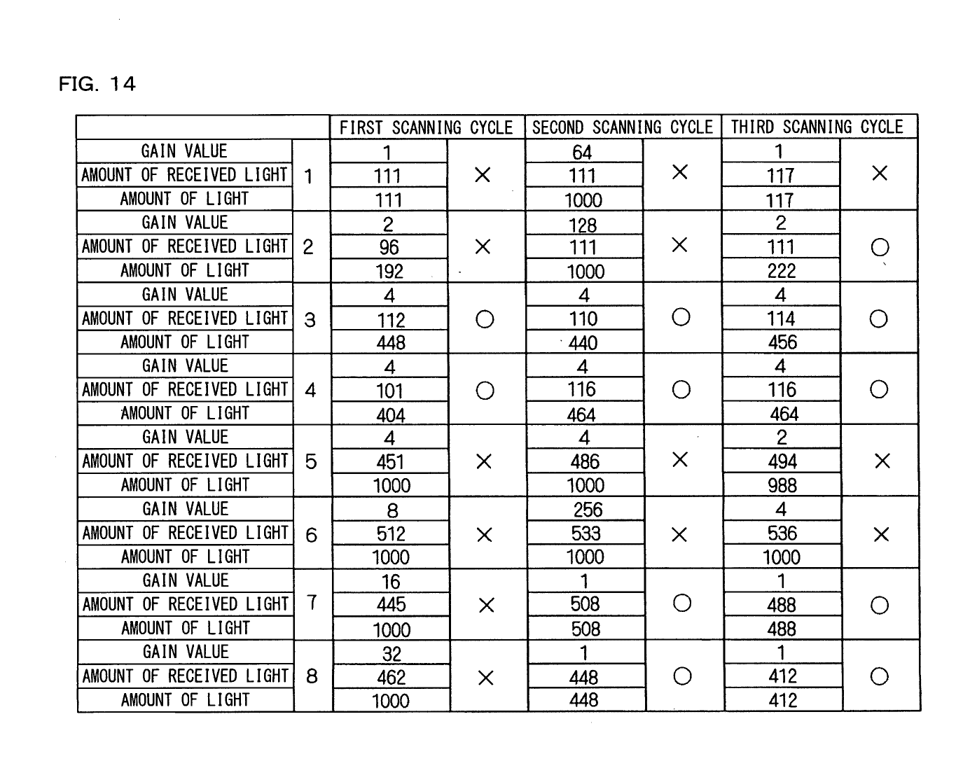

Specific exemplary gain value calculation is shown below. FIG. 14 is an illustrative diagram of gain value calculation for when a gain value modification process according to the second embodiment of the present invention shown in FIG. 11 is repeatedly performed on eight scanning lines. The numbers in the far left column of FIG. 14 are numbers identifying eight scanning lines; specifically, the numbers indicate, from the top, scanning lines #1, #2, . . . #8. Note that the gains A to I shown in FIG. 12 are respectively set to “1”, “2”, “4”, “8”, “16”, “32”, “64”, “128”, and “256”.

In an example of FIG. 14, a gain value is set under rules where an initial value of a gain value is “1” and when an amount of light (an amount of received light× a gain value) for a scanning line which is obtained last time is within a range of not less than 200 and not more than 500 a gain value for the scanning line which is used last time is maintained, and when outside the range a gain value is set to a gain value in the next place stored in the RAM 17.

For the scanning line #1 in the first scanning cycle, since the amount of light is “111” and thus the amount of light (an amount of received light× a gain value) is outside the range of not less than 200 and not more than 500, it can be determined that the gain value “1” set as a reading condition is not appropriate. Hence, “x” which is information indicating that a reading result for the scanning line #1 in the first scanning cycle has not been normal is stored in the RAM 17 as reading result information, and the gain value “2” which is stored in the RAM 17 in the next place to the gain value “1” for the scanning line #1 is set as a gain value for the scanning line #2.

For the scanning line #2 in the first scanning cycle, since the amount of light is “192” and thus the amount of light (an amount of received light× a gain value) is outside the range of not less than 200 and not more than 500, it can be determined that the gain value “2” set as a reading condition is not appropriate. Hence, “x” which is information indicating that a reading result for the scanning line #2 in the first scanning cycle has not been normal is stored in the RAM 17 as reading result information, and the gain value “4” which is stored in the RAM 17 in the next place to the gain value “2” for the scanning line #2 is set as a gain value for the scanning line #3.

For the scanning line #3 in the first scanning cycle, since the amount of light is “448” and thus the amount of light (an amount of received light× a gain value) is within the range of not less than 200 and not more than 500, it can be determined that the gain value “4” set as a reading condition is appropriate. Hence, “◯” which is information indicating that a reading result for the scanning line #3 in the first scanning cycle is normal is stored in the RAM 17 as reading result information, and the gain value “4” for the scanning line #3 is set as it is as a gain value for the scanning line #4.

For the scanning line #4 in the first scanning cycle, since the amount of light is “404” and thus the amount of light (an amount of received light× a gain value) is within the range of not less than 200 and not more than 500, it can be determined that the gain value “4” set as a reading condition is appropriate. Hence, “◯” which is information indicating that a reading result for the scanning line #4 in the first scanning cycle is normal is stored in the RAM 17 as reading result information, and the gain value “4” for the scanning line #4 is set as it is as a gain value for the scanning line #5.

For the scanning line #5 in the first scanning cycle, since the amount of light is a saturation amount of light and thus the amount of light (an amount of received light× a gain value) is outside the range of not less than 200 and not more than 500, it can be determined that the gain value “4” set as a reading condition is not appropriate. Hence, “x” which is information indicating that a reading result for the scanning line #5 in the first scanning cycle has not been normal is stored in the RAM 17 as reading result information, and the gain value “8” which is stored in the RAM 17 in the next place to the gain value “4” for the scanning line #5 is set as a gain value for the scanning line #6.

Thereafter, for the first scanning cycle, a gain value is sequentially set for each scanning line by the above-described steps. This is because in the first scanning cycle, a gain value which is a reading condition used last time is not present for each scanning line.

Then, for the scanning line #1 in a second scanning cycle, “x” which is information indicating that a reading result in the first scanning cycle has not been normal is read from reading result information stored in the RAM 17. Hence, as in the first scanning cycle, a gain value as a reading condition to be used is set based on an immediately previous gain value and amount of light.

Specifically, for the scanning line #1 in the second scanning cycle, since the amount of light is a saturation amount of light and thus is outside the range of not less than 200 and not more than 500, it can be determined that the gain value “64” set as a reading condition is not appropriate. Hence, “x” is stored in the RAM 17 as information indicating that a reading result for the scanning line #1 in the second scanning cycle is not normal, and the gain value “128” which is stored in the RAM 17 in the next place to the gain value “64” for the scanning line #1 is set as a gain value for the scanning line #2.

Then, for the scanning line #2 in the second scanning cycle, “x” which is information indicating that a reading result in the first scanning cycle has not been normal is read from reading result information stored in the RAM 17. Hence, as in the first scanning cycle, a gain value as a reading condition to be used is set based on an immediately previous gain value and amount of light.

Specifically, for the scanning line #2 in the second scanning cycle, too, since the amount of light is a saturation amount of light and thus is outside the range of not less than 200 and not more than 500, it can be determined that the gain value “128” set as a reading condition is not appropriate. Hence, “x” is stored in the RAM 17 as information indicating that a reading result for the scanning line #2 in the second scanning cycle is not normal.

For the scanning line #3 in the second scanning cycle, “◯” which is information indicating that a reading result in the first scanning cycle is normal is read from reading result information stored in the RAM 17. Hence, a gain value used in the first scanning cycle is set as it is as a reading condition. That is, the gain value “4” is set as a gain value for the scanning line #3.

Thereafter, similarly, a gain value is sequentially set and when the gain value “256” which is a maximum value is set, the order returns to the gain value “1” stored in first place and the gain value “1” is set as a gain value stored in the next place.

As described above, also in the second embodiment, for those scanning lines at which reading has been able to be performed normally ever once, reading can be continuously performed normally thereafter, and only for those scanning lines at which reading has not been able to be performed normally, a reading condition can be allowed to converge to an appropriate reading condition, and thus, the total time required for reading to be stabilized can be reduced.

Moreover, even when the amount of light varies depending on the location of a scanning line from the start of a reading process of a bar code 2 until the setting of a gain value is completed and thus gain values cannot be uniformly set, e.g., when a bar code 2 is affixed to a cylindrical to-be-detected object 3 or when scanning lines only hit part of a bar code 2, a gain value or the like which is an appropriate reading condition can be promptly identified, enabling to provide a bar code reading apparatus capable of performing stable bar code reading.

Note that although in the first and second embodiments scanning is cyclically performed with certain regularity along a plurality of different scanning lines by mounting the polygon mirror 12 such that the polygon mirror 12 is tilted by a predetermined angle θ relative to the rotating shaft 30, the mirror mechanism is not limited to the polygon mirror 12 and may be a galvanometer mirror. In a case of using a galvanometer mirror, to enable to cyclically perform scanning with certain regularity along a plurality of different scanning lines, for example, a rotating shaft with two shafts orthogonal to each other that performs postural control of the galvanometer mirror may be provided and two-axis control may be performed.

Note also that although in the first and second embodiments a determination as to whether a received-light signal has been able to be read normally is made based on whether the amount of light of the received-light signal is within a predetermined range, the determination method is not particularly limited thereto. For example, since a reading target is a bar code 2, such a determination may be made based on whether no-signal zones present on both ends of the bar code 2 have been able to be detected or whether a start signal/end signal of the bar code 2 have been able to be detected or whether information known to be included as bar code information has been included, or based on a combination thereof.

In addition, the present invention is not limited to the above-described embodiments and thus, needless to say, various modifications, substitutions, and the like, may be made thereto without departing from the spirit and scope of the invention.

What is claimed is:

1. A bar code reading apparatus including: a light-emitting element that emits light; a mirror mechanism that changes an emission direction of the light emitted from the light-emitting element so that the light can cyclically scan a bar code at a plurality of different locations, with certain regularity; and a light-receiving element that receives reflected light from the bar code, and obtaining bar code information based on a received-light signal obtained by photoelectrically converting reflected light for each scanning line received by the light-receiving element, the bar code reading apparatus comprising:
a reading result storing unit that stores reading result information about whether bar code information has been able to be read normally in a scanning cycle unit, in association with the plurality of locations and information on a condition set upon reading;
a determining unit that determines, based on stored reading result information which is obtained in an immediately previous scanning cycle, whether bar code information in an identical relative location in the immediately previous scanning cycle has been able to be read normally; and
a condition setting unit that reads, when the determining unit determines that bar code information has been able to be read normally, information on a condition set upon reading in the immediately previous scanning cycle, and sets, when the determining unit determines that bar code information has not been able to be read normally, information on a condition that differs from information on a condition set upon reading in the immediately previous scanning cycle.

2. The bar code reading apparatus according to claim 1, wherein
the information on a condition includes a gain value set by an amplifier circuit that amplifies the received-light signal, and
in a first scanning cycle after a start of scanning, the condition setting unit calculates a new gain value based on an immediately previously stored gain value and amount of received light which are obtained when scanning is performed at another location; and in a subsequent scanning cycle, the condition setting unit reads, when the determining unit determines that bar code information has been able to be read normally, a gain value in an identical relative location in an immediately previous scanning cycle, and calculates, when the determining unit determines that bar code information has not been able to be read normally, a new gain value based on an immediately previously stored gain value and amount of received light which are obtained when scanning is performed at another location.

3. The bar code reading apparatus according to claim 1, wherein
the information on a condition includes a gain value set by an amplifier circuit that amplifies the received-light signal,
the bar code reading apparatus further comprises a gain value storage unit that stores a predetermined number of gain values to be set, and
the condition setting unit reads, when the determining unit determines that bar code information has been able to be read normally, a same gain value as that used to read the bar code information, in scanning at a next location, and sets, when the determining unit determines that bar code information has not been able to be read normally, a gain value by cyclically changing the stored gain values.

4. A bar code reading method that can be performed by a bar code reading apparatus including: a light-emitting element that emits light; a mirror mechanism that changes an emission direction of the light emitted from the light-emitting element so that the light can cyclically scan a bar code at a plurality of different locations, with certain regularity; and a light-receiving element that receives reflected light from the bar code, and obtaining bar code information based on a received-light signal obtained by photoelectrically converting reflected light for each scanning line received by the light-receiving element, the method comprising:
storing reading result information about whether bar code information has been able to be read normally in a scanning cycle unit, in association with the plurality of locations and information on a condition set upon reading;
determining, based on stored reading result information which is obtained in an immediately previous scanning cycle, whether bar code information in an identical relative location in the immediately previous scanning cycle has been able to be read normally; and
reading, when it is determined that bar code information has been able to be read normally, information on a condition set upon reading in the immediately previous scanning cycle, and setting, when it is determined that bar code information has not been able to be read normally, information on a condition that differs from information on a condition set upon reading in the immediately previous scanning cycle.

5. The bar code reading method according to claim 4, wherein
the information on a condition includes a gain value set by an amplifier circuit that amplifies the received-light signal, and
the method further comprises:
in a first scanning cycle after a start of scanning, calculating a new gain value based on an immediately previously stored gain value and amount of received light which are obtained when scanning is performed at another location; and
in a subsequent scanning cycle, when it is determined that bar code information has been able to be read normally, reading a gain value in an identical relative location in an immediately previous scanning cycle, and when it is determined that bar code information has not been able to be read normally, calculating a new gain value based on an immediately previously stored gain value and amount of received light which are obtained when scanning is performed at another location.

6. The bar code reading method according to claim 4, wherein
the information on a condition includes a gain value set by an amplifier circuit that amplifies the received-light signal, and
the method further comprises:
storing a predetermined number of gain values to be set; and
when it is determined that bar code information has been able to be read normally, reading a same gain value as that used to read the bar code information, in scanning at a next location, and when it is determined that bar code information has not been able to be read normally, setting a gain value by cyclically changing the stored gain values.
